(19) United States
(12) Patent Application Publication
(10) Pub. No.: US 2009/0016489 A1
(43) Pub. Date: Jan. 15, 2009

(54) X-ray generator with rotating anode

(76) Inventor: Gunter Danz, Gross-Zimmern (DE)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/977,136

(22) Filed: Oct. 19, 2007

Related U.S. Application Data
(63) Continuation of application No. PCT/EP2006/002535, filed on Mar. 20, 2006.

(30) Foreign Application Priority Data
Mar. 30, 2005 (DE) 10 2005 014 454.3
Apr. 20, 2005 (DE) 10 2005 018 369.7

(51) Int. Cl. H05G 1/66

(52) U.S. Cl. 378/94

(57) ABSTRACT

The invention concerns an X-ray generator with rotating anode for generating X-rays, comprising a fixed cathode, as well as a rotating anode which is arranged on a motor driven rotor, the cathode and the rotating anode being introduced into a vacuum tank. The inventive X-ray generator with rotating anode comprises: a balancing device which is integrated in the X-ray generator and which includes a control device which is connected to the vacuum tank, and an actuating device which is connected to the rotor and which includes at least two compensation masses capable of being angularly displaced relative to each other, by means of the control device; a vibration sensor for detecting the vibrations of the X-ray generator; a position sensing device for detecting the position of the compensation masses; and a controller which is coupled to the balancing device and controlled by a microprocessor, for controlling the balancing device which is configured to calculate an imbalance, and which can move the compensation rings, via the control device, so as to reduce vibrations induced by the imbalance. The calibration is carried out by generating an imbalance vector, by moving in a specific manner one compensation mass at an angle α or by a specific distance relative to the axis of rotation.

The invention concerns an X-ray generator with rotating anode and methods for balancing the same.

X-ray generators with rotating anodes are nowadays used for testing materials and also for medical purposes. Since the rotating anodes in current X-ray generators with rotating anode are rotating with high speed up to 20,000 rotations per minute (rpm), the residual imbalances in the rotating system cause vibrations. One reason for an imbalance, which changes during operation, in particular during heating of the electrodes, is the thermal expansion of the electrodes. The oscillations caused by the imbalance generate vibrations which shorten the operation lifetime of the bearings. Additionally, noise is generated by the vibration which, when the X-ray generator is used for medical purposes, is sensed by the patients as being uncomfortable. Furthermore, the oscillations in the X-ray generator caused by the imbalance, degrade the picture quality of the picture generated during X-ray screening.

It is an object of the invention, to provide an X-ray generator with rotating anode which is improved with respect to the vibration problems.

For this purpose, the X-ray generator for generating X-rays having a stationary cathode and a rotating anode arranged on a motor driven rotor, wherein the cathode and the rotating anode are housed in a vacuum container, is characterized by at least a balancing device which is integrated in the X-ray generator and which includes a control device which is connected to the vacuum container, and an actuating device which is connected to the rotor and which includes at least two compensation masses capable of being angularly displaced relative to each other by means of the control device; a vibration sensor for detecting vibrations of the X-ray generator, a position sensing device for detecting the position of the compensation masses; and a controller which is coupled to the balancing device and controlled by a microprocessor for controlling the balancing device which is configured to calculate an imbalance, and which can move the compensation rings via the control device so as to reduce vibrations induced by the imbalance.

It came advantageously apparent that the integration of the balancing device into the X-ray generator is possible in spite of the restricted space within in the generator, and that also balancing devices with little bulk are sufficient to balance potential imbalances within the X-ray generator or tube. On the basis of the integration of the balancing device into the X-ray generator with rotating anode into the rotating system, the upcoming vibration can be automatically corrected without interrupting the operation of the generator. If an additional imbalance comes up during the operation, additional balancing can be done without interrupting the operation of the generator. The vibrations picked up by the vibration sensor are calculated in the controller. The controller adjusts the compensation rings such that the vibrations caused by the imbalance are automatically reduced. The compensation weights are, therein, adjusted according to the known spread ankle method. There are no undesired resonance oscillations during the initial raising of the operation speed.

An advantageous embodiment of the invention is characterized in that, for balancing the X-ray generator with respect to a plurality of planes, a balancing device for each balancing plane is provided. The X-ray generator according to the invention, can, therefore, also be balanced in a plurality of balancing planes if necessary.

An advantageous embodiment of the invention is characterized in that the controller is provided for controlling of the plurality of balancing devices.

An advantageous embodiment of the invention is characterized in that the balancing device is a ring balancing device having a stator arranged in the vacuum container serving as control device, and two balancing rings connected to the rotor acting as compensation masses. The ring balancing devices having a stator as control device and two balancing rings connected to the rotor acting as compensation masses, are known for balancing tool holders, grinding wheels and the like in mechanical engineering, see DE-PS 4337001. Therein, the balancing rings may be adjusted as desired by electromagnetic forces between the stator which is arranged at a portion of the circumference of the balancing rings and comprises a plurality of magnetic circuits, and the balancing rings which contain a plurality of magnets, in order to compensate the imbalance of the rotor. It has been proven to be advantageous that such a balancing system is also applicable to X-ray generators with rotating anode, and that they can be housed there in spite of the restricted space conditions.

A further advantageous embodiment of the invention is characterized in that the stator is arranged on the outside of the vacuum container, and the actuating device is arranged within the vacuum container opposite to the stator. In principle, also the stator could be arranged in the inside of the X-ray generator near to the actuating device. By the fact that the stator is arranged on the outside of the vacuum container and the actuating device is arranged within the vacuum container opposite to the stator, the restricted space offered in the X-ray generator is taken into account in an advantageous way. The distance between the actuating device and the wall of the vacuum container can, therein, be small.

A further advantageous embodiment of the invention is characterized in that the vibration sensor is arranged on the outside of the vacuum container. Since the oscillations caused by the imbalance, are transferred to the vacuum container, this position is adapted to sense the oscillations without burdening the interior space of the vacuum container by additional devices.

A further advantageous embodiment of the invention is characterized in that the position detector device comprises magnets on the compensation weights and a position sensor responding to the magnets. Thereby, a reliable detection of the position of the compensation weights is possible with low constructional effort.

A further advantageous embodiment of the invention is characterized by a speed detecting device for detecting the rotational speed of the rotor. Thereby, the rotational speed of the rotor may be sensed by a device of the balancing system, and it can be taken into account during a valuation of the imbalance values.

A further advantageous embodiment of the invention is characterized in that the speed detecting device comprises a magnet on the rotor and a speed sensor responding to the magnet. As with the position of the detecting device, this is an advantageous solution also in this arrangement in order to detect the revolution speed without additional constructional effort.

A further advantageous embodiment of the invention is characterized in that the position sensor and/or the speed sensor are Hall-sensors. Such sensors are accurate, have a small bulk and have been proven as being advantageous in such applications.

A further advantageous embodiment of the invention is characterized in that the vacuum container is a glass bulb. The correction of the imbalance which is the reason for the oscillations, is carried out through the glass bulb by means of an electromagnetic adjustment of the compensation rings in the actuating device according to the spread angle method. The speed detection and the position detection of the compensation rings are carried out also through the glass bulb by means of magnets in the rotating system and Hall-sensors arranged outside.

Balancing devices operate, up to now, according to the method that the compensation masses are adjusted or spread out in a predetermined direction as long as the oscillations of the machine become smaller. If the oscillations become larger upon displacement of the compensation masses, the direction of the displacement is reversed during adjustment of the compensation masses. The adjustment according to this method is repeated until the balancing method is terminated upon reaching of a predetermined residual imbalance. It is disadvantage therein that often a long time is required for the balancing operation in this “trial and error” method.

With respect to X-ray generators with rotating anode, immediate balancing already during speeding up and also during operation is very important because of the high operation speed up to 20,000 rpm. The “trial and error” method according to the state of the art is, therein, insufficient in many cases. Therefore, it is desired furthermore, to provide a method for balancing X-ray generators with rotating anode according to the invention, by which method the balancing of the X-ray generator can be accelerated and made more accurate.

Therefore, balancing of the X-ray generator according to the invention or according to advantageous embodiments of the invention respectively is characterized in that

(a) the compensation masses are brought into their zero positions in which the imbalance vectors generated by them, cancel each other, that
(b) the imbalance vector which is present then, is measured according to magnitude and direction in a known manner, that
(c) at least one of the compensation masses is displaced by an arbitrary angle α or in its distance from the rotational axis whereby an additional imbalance is generated with a calibration imbalance vector, that
(d) the angle α or the displacement of the distance is detected, that
(e) the total imbalance vector which is present then, is measured according to magnitude and direction in a known manner, that
(f) a calibration imbalance vector is calculated from the imbalance vector and the total imbalance vector, and that
(g) the compensation masses are moved from the zero positions such that the imbalance vector V is compensated. The calibration is, therefore, essentially made by generating an imbalance vector by means of a well defined displacement of a compensation mass by an angle α or by a specified distance from the rotational axis. The identification of the transfer characteristic is, therefore, made purposeful and automatic as opposed to the “trial and error” principal of known balancing systems.

An advantageous embodiment of the method of the invention is characterized in that, in step (a), the displacement of the compensation masses from the zero positions according to direction of displacement and/or distance of displacement is stored during a balancing operation, and that the compensation masses are brought into the zero positions thereby that they are moved back by the respective, stored displacement distance in the opposite displacement direction. Therein, it is advantageous that no additional hardware conditions have to be provided for carrying out this method.

An advantageous embodiment of method of the invention is characterized in that, in step (a) the direction of displacement and/or the displacement distance of the compensation masses is detected by means of an encoder device. Thereby, the actual positions, i.e. the absolute positions according to distance and displacement direction, can be detected in an advantageous way such that moving back of the compensation masses to the zero positions may be carried out accordingly.

A further advantageous embodiment of the method of the invention is characterized in that, in step (c), the displacement angle α is detected by means of an encoder device.

In step (a), the direction of displacement and/or the distance of displacement of the compensation masses may be detected by a step generator arranged at the displacement unit. Alternatively, the distance of displacement of the compensation masses may be detected by means of the time duration of the displacement movement, and the direction of displacement may be detected by means of the rotational direction of the displacement unit, in step (a). A further possibility is that, in step (a), the distance of displacement is detected by means of the power consumption of the displacement of the compensation masses, and the direction of displacement is detected through the rotational direction of the displacement unit.

In step (a), the compensation masses may be moved until it is detected by two sensors arranged opposite to each other that the compensation masses are located at the sensors. By means of the sensors, it is, thereby, detected when the compensation masses are displaced by 180° with respect to each other or take the positions 0° and 180° respectively.

In step (c), the displacement angle may be detected by means of a step generator arranged at the displacement unit or by means of the time duration of the displacement movement or by means of the current consumption during the displacement.

Embodiments of the invention are now described with reference to the drawings in which:

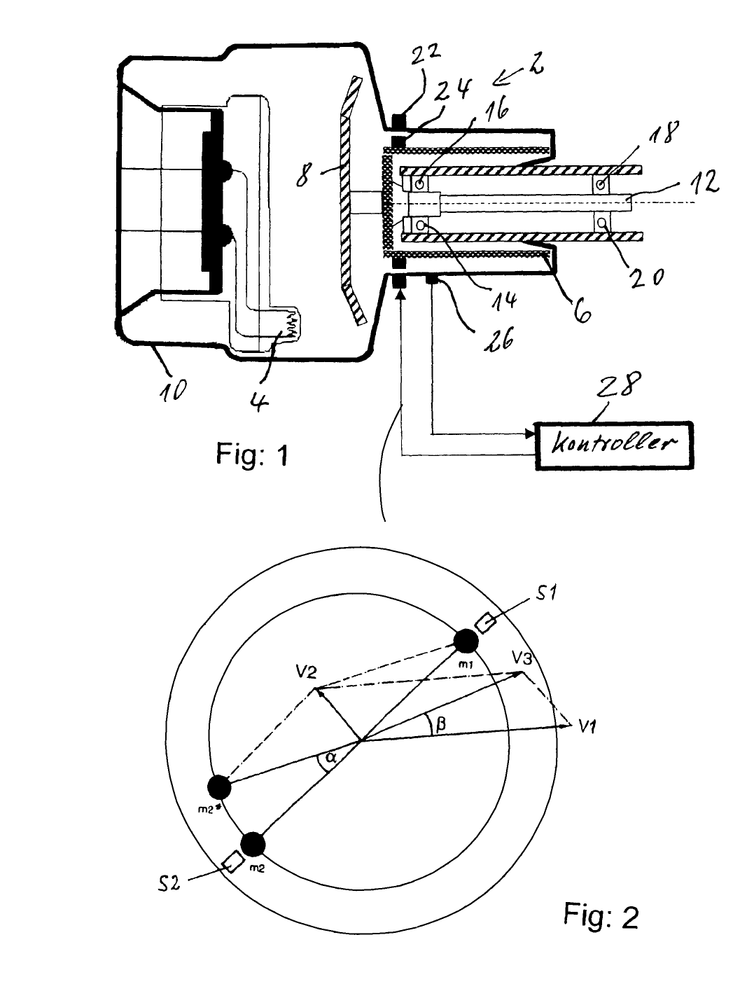

FIG. 1 is a schematic representation of an X-ray generator with rotating anode having a balancing device;

FIG. 2 is a schematic representation of a method for balancing an X-ray generator with rotating anode according to the invention; and

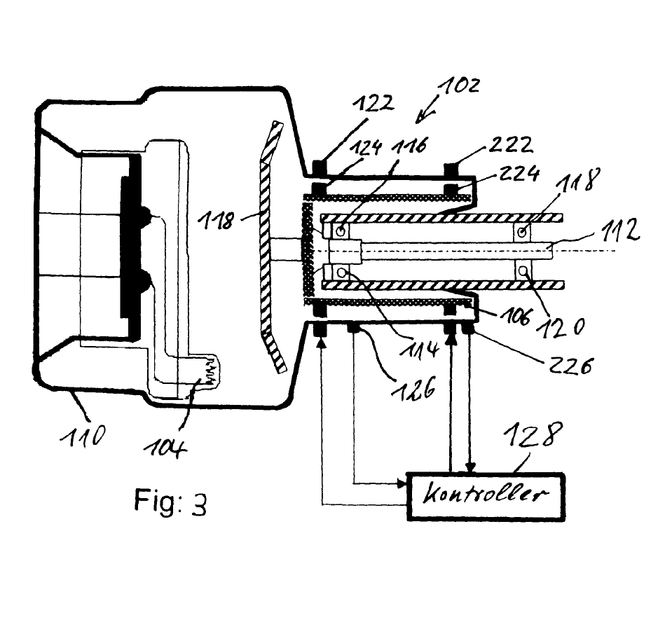

FIG. 3 is a schematic representation of an X-ray generator with rotating anode having a balancing device each in two balancing planes.

An X-ray generator with rotating anode 2 for generating X-rays is in FIG. 1 comprising a stationary cathode 4 and a rotary anode 8 arrange on a motor driven rotor 6, wherein the cathode 4 and the rotating anode 8 are housed in a vacuum container or a glass tube 10 respectively. The rotor 6 and the rotating anode 8 are seated on a motor driven drive shaft 12 which is rotatable supported by roller bearings 14, 16, 18, 20. Such X-ray generators with rotating anode are known in the state of the art.

The X-ray generator with rotating anode according to an embodiment of the invention as shown in FIG. 1, comprises a balancing device which is integrated into the X-ray generator 2 and which comprises an control device 22 connected to the glass bulb, and an actuating device having at least two compensation weights or masses 24 which are angularly displaceable by means of the control device 22, arranged on the rotor 6. In the shown embodiment, the balancing device is a so called ring balancing device having a stator arranged outside as a control device 22 and two balancing rings connected to the rotor as compensation masses. The stator is, therein, arranged on the outside of the glass bulb, and the actuating device is arranged on the inside of the glass bulb opposite to the stator whereby an air gap is present between the actuating device and the inside of the glass bulb.

A vibration sensor 26 for detecting vibrations of the X-ray generator is arranged on the outside of the glass bulb. A position detecting device comprising magnets on the compensation masses and a position sensor (not shown) responding to the magnets, serves for detecting the position of the compensation masses. A rotational speed detecting device (not shown) for detecting the rotational speed of the rotor is provided and comprises a magnet on the rotor and a speed sensor responding to the magnet. The position sensor and the speed sensor may be Hall-sensors.

The vibration sensor 26 and the control device 22 as well as the position detector device and the speed detector device are coupled to a controller 28 controlled by a micro processor which controller is provided for controlling the balancing device. For this purpose, the imbalance is calculated in the controller 28, and the compensating rings or masses respectively are displaced by means of the control device 22 such that the vibrations caused by the imbalance are reduced.

At first, the compensation masses m1, m2 present in the automatic balancing apparatus, are moved to the neutral zero positions wherein the compensation masses m1, m2 are located displaced by 180° with respect to each other. The fact that the compensation masses m1, m2 are in the zero positions, is detected by sensors S1, S2. The output signals of the sensors S1, S2 are passed on to the main control device thereupon this device causes the measurement circuit to detect vector V1 comprising the actual imbalance of the system consisting of balancing apparatus and rotational body. After V1 has been measured, at least one of the compensation masses is displaced by an angle α as shown by the compensation mass m2*. By displacing the compensation mass m2* by the angle α, an additional im-balance having the imbalance vector V2 is generated. The angle β is the angle between the imbalance vector V1 and the imbalance vector V3 which results from the displacement of the compensation mass m2*. The value of the angle α is detected in the balancing apparatus and stored.

The resulting vector V2 forms, together with the actual imbalance, a total imbalance having the total imbalance vector V3 which is measured according to magnitude and direction. The calculating circuit in the balancing apparatus calculates the resulting imbalance vector V2 from the resulting vector V3 and the imbalance vector V1 according to the formula:

V2=V3−V1.

Thereby it is known which imbalance vector V2 is the result of the movement of the compensation mass m2 by the angle α, and these values can be used to calculate the positions to which the compensation masses may be moved intentionally in order to compensate the existing imbalance V1.

In case of a change of the distance of the compensation masses from the rotational axis, the system is calibrated in an analoguous way, which need not be explained in more detail.

By displacing the compensation mass m2 by a known angular value or by changing the distance of the compensation mass from the rotational axis, the system consisting out of balancing apparatus and rotation body is calibrated and in fact in relative amounts. The phase shift and the damping of the oscillation amplitude of the system are also taken into account in this calibration procedure. Therefore, the “trial and error” method according to the state of the art is eliminated, and the compensation masses can be moved in specifically into the correct positions.

If it is necessary to balance in a plurality of planes, which is dependent on the mass distribution of the rotating part of the X-ray generator, one balancing apparatus is each arranged with respect to each of the balancing planes. Finding the balancing planes is carried out by the person skilled in the art in a known manner.

FIG. 3 shows an example of an X-ray generator with rotating anode according to an embodiment of the invention for balancing in two planes. The X-ray generator with rotating anode comprises a first balancing device and a second balancing device which are integrated into the X-ray generator 102 and which comprise a first control device 122 connected to the glass bulb 110, a second control device 222 connected to the glass bulb 110, a first actuating device 124 connected to the rotor 106 and a second actuating device 224 connected to the rotor 106, each having at least two compensation devices angularly displaceable with respect to each other by means of the operating devices 122, 222. In the embodiment shown, the balancing devices are so called ring balancing devices having two stators arranged outside as operating devices 122, 222 and four (two in each plane) balancing rings connected to the rotor as compensation masses. The stators are arranged, therein, on the outside of the glass bulb, and actuating devices are arranged on the inside of the glass bulb opposite to the respective stator whereby an air gap is present between the actuating device and the inside of the glass bulb.

A vibration sensor 126 for detecting vibrations of the X-ray generator is provided on the outside of the glass bulb. A position detector device comprising magnets on the compensation masses and a position sensor (not shown) responsive to the magnets, serves for detecting the position of the compensation masses. The rotational speed detector device (not shown) for detecting the rotational speed of the rotor is provided and comprises a magnet on the rotor and a speed sensor responding to the magnet. The position sensor and the speed sensor may be Hall-sensors.

The vibration sensor 126 and the operation devices 122, 222 as well as the position detecting device and the speed detecting device are coupled to a micro processor controller 128 which is provided for controlling the balancing devices. For this purpose, the imbalance in the respective balancing plane is calculated in the controller 128, and the compensation rings or masses respectively are displaced by the control devices 122, 222 such that the vibrations caused by the imbalance, are reduced.

As has been described above in the case of one balancing plane, the compensation masses are at first positioned into their neutral position. The respective compensation masses in the respective planes are displaced in a defined position one after another. From measuring the influences of the displacement of the compensation mass on the vibration in the respective measurement plane the influence coefficient are directly determined. The influence coefficient determined in this way, are then used, as described above, for calculating the balancing positions of the compensation masses.

1-15. (canceled)

16. An X-ray generator with rotating anode for generating X-rays characterized by a stationary cathode and a rotating anode arranged on a motor driven rotor, the cathode and the rotating anode housed in a vacuum container, the X-ray generator comprising:
at least one balancing device which is integrated in the X-ray generator and which includes:
a control device which is connected to the vacuum container, and an actuating device which is connected to the motor driven rotor and which includes at least two compensation masses capable of being angularly displaced relative to each other by means of said control device;
a vibration sensor for detecting vibrations of the X-ray generator,
a position detecting device for detecting positions of said at least two compensation masses; and,
a controller which is coupled to said at least one balancing device and controlled by a microprocessor for controlling said at least one balancing device which is configured to calculate an imbalance, and which can move said at least two compensation masses via said control device so as to reduce vibrations induced by the imbalance.

17. The X-ray generator according to claim 16, characterized in that, for balancing the X-ray generator with respect to a plurality of planes, a balancing device for each balancing plane is provided.

18. The X-ray generator according to claim 16, characterized in that said at least one balancing device is a ring balancing device having a stator arranged in the vacuum container serving as actuating device, and two balancing rings connected to the motor driven rotor acting as compensation masses.

19. The X-ray generator according to claim 18, characterized in that said stator is arranged on the outside of the vacuum container, and said actuating device is arranged within the vacuum container opposite to said stator.

20. The X-ray generator according to claim 16, characterized in that said vibration sensor is arranged on the outside of the vacuum container.

21. The X-ray generator according to claim 16, characterized in that said position detecting device comprises magnets on compensation masses of said at least two compensation masses and a position sensor responding to the magnets.

22. The X-ray generator according to claim 16, characterized by a speed detecting device for detecting a revolution speed of the motor driven rotor.

23. The X-ray generator according to claim 22, characterized in that said speed detecting device comprises a magnet on the motor driven rotor and a speed sensor responding to said magnets.

24. The X-ray generator according to claim 22, characterized in that said speed sensor is a Hall-sensor.

25. The X-ray generator according to claim 16, characterized in that said position sensor is a Hall-sensor.

26. The X-ray generator according to claim 16, characterized in that the vacuum container is a glass bulb.

27. A method for balancing of the X-ray generator according to claim 16 wherein,
(a) compensation masses of said at least two compensation masses are brought into zero positions in which imbalance vectors generated by them, cancel each other, that
(b) an imbalance vector which is present then, is measured according to magnitude and direction in a known manner, that
(c) at least one of said compensation masses is displaced by an arbitrary angle α or its distance from an associated rotational axis whereby an additional imbalance is generated with a calibration imbalance vector, that
(d) said angle α or the displacement of said distance is detected, that
(e) a total imbalance vector which is present then, is measured according to magnitude and direction in a known manner, that
(f) said calibration imbalance vector is calculated from said imbalance vector and said total imbalance vector, and that
(g) said compensation masses are moved from zero positions such that said imbalance vector is compensated.

28. The method according to claim 27, characterized in that displacement of said compensation masses from the zero positions according to direction of displacement and/or distance of displacement is stored during a balancing operation, and that said compensation masses are brought into zero positions such that they are moved back by a respective, stored displacement distance in an opposite displacement direction.

29. The method according to claim 27, characterized in that a direction of displacement and/or a displacement distance of said compensation masses is detected by means of an encoder device.

30. The method according to claim 27, characterized in that said displacement angle α is detected by means of an encoder device.
